(19) United States
(12) Patent Application Publication
(10) Pub. No.: US 2026/0100388 A1
(43) Pub. Date: Apr. 9, 2026

(54) DISTRIBUTED CAPACITIVE ENERGY STORAGE FOR FLOW BATTERIES

(71) Applicant: Microsoft Technology Licensing, LLC, Redmond, WA (US)

(72) Inventors: Ruslan NAGIMOV, Snohomish, WA (US); Jonathan Brooks HORNER, Everett, WA (US)

(21) Appl. No.: 18/905,286

(22) Filed: Oct. 3, 2024

(51) Int. Cl. H01M 8/04082; H01G 11/02; H01M 8/18; H01M 16/00

(52) U.S. Cl. CPC H01M 8/04216; H01G 11/02; H01M 8/188; H01M 16/003; H01M 2250/10

(57) ABSTRACT

“Purely electrical” solutions to power oscillations involve expensive storage techniques (e.g., batteries and/or capacitors) or wasted energy in “dummy loads” (e.g., resistive banks and/or heaters). Some power delivery systems may incorporate flow batteries as part of the energy storage and delivery solution, particularly using piped electrolyte to distribute power directly to storage racks. For longer duration fluctuations in power consumption, flow batteries may store power during off-peak demand periods and release power during peak demand periods. However, flow batteries typically do not react fast enough to compensate for rapid fluctuations in power consumption. The presently disclosed technology utilizes the pipework of electrolyte distribution systems in place for the flow battery as a distributed electrolytic capacitor. This form of “fast” energy storage is ideally suited to complement “slow” chemical energy storage of a flow battery and is thus capable of acting as a power-smoothing solution and a UPS supplement or replacement.

### BACKGROUND

Cloud computing is the on-demand availability of computer system resources, especially data storage (cloud storage) and computing power, without direct active management by the user. Large cloud computing networks often have functions distributed over multiple locations, each of which is a data center. Large-scale machine-learning (ML) and/or artificial intelligence (AI) model training is a distributed computing computation, often performed as a cloud computing computation, that can involve thousands of graphical processing units (GPUs) interconnected by high-bandwidth networks within one or more data centers. To train a large language model, for example, a computational workload is partitioned across thousands of GPUs interconnected in a GPU cluster, which can draw power in a synchronous manner, often periodically and repeatedly fluctuating from nearly zero to full load.

### SUMMARY

Implementations described and claimed herein address the problems described below by providing a flow battery with capacitive energy storage. The flow battery comprises an electrochemical cell to reversibly convert between chemical energy stored in an electrolyte and electrical energy, a power supply connected to the electrochemical cell, and a pipe network to circulate the electrolyte through the electrochemical cell. The electrolyte serves as a first electrode for the capacitive energy storage. One or more sections of the pipe network include a metal contact running an interior length of the pipe network serving as a second electrode for the capacitive energy storage, and an insulating coating applied over the metal contact and separating the metal contact from the electrolyte. The insulating coating serves as a dielectric for the capacitive energy storage. A first lead runs from the metal contact to the power supply. The first lead connects the capacitive energy storage of the pipe network to the power supply.

Other implementations are also described and recited herein.

### BRIEF DESCRIPTION OF THE DRAWINGS

FIG. 1 illustrates a graphical configuration of a flow battery with distributed capacitive energy storage powering an array of servers.

FIG. 2 is a diagram of a flow battery with distributed capacitive energy storage powering an electrical load.

FIG. 3 is a diagram of a flow battery with independent distributed capacitive energy storage powering an electrical load.

FIG. 4 illustrates example operations for using a flow battery to smooth both “slow” and “fast” fluctuations in power consumption by a fluctuating power load.

### DETAILED DESCRIPTION

Graphical processing unit (GPU) servers are servers with one or more graphics processing units (GPUs) that offer increased power and speed for running computationally intensive tasks, such as video rendering, data analytics, and machine learning. In datacenters tasked with large-scale machine-learning (ML) and/or artificial intelligence (AI) model training, large groupings of GPU servers are arranged in clusters and tasked with a distributed computational workload. Once the computational workload is complete, a collecting operation (e.g., Allreduce) collects the data from the different GPU servers and combines the data into a global result. This result is then distributed back to the GPU servers and a next computational workload begins. As a result, the computation workload occurs in stages with the collecting operation completing a stage. While the collecting operation is running, the GPU servers are substantially idled waiting for the next computational workload to begin. Tensor processing unit (TPU) servers are servers with tensor processing units (TPUs) for neural network machine learning. The presently disclosed technology may similarly apply to tensor processing unit (TPU) servers as described with particularity herein with reference to GPU servers.

As a result, the computational workload on the GPU servers is periodic and the GPUs cycle between on and off states together. This yields a synchronous workload that causes power draw by the GPU servers to periodically and repeatedly fluctuate from nearly zero to full load. This can cause issues with the power delivery systems or power grid, stress uninterruptible power supply (UPS) batteries and generators, cause voltage oscillations, and potentially propagate a resulting noise back into the power grid.

“Purely electrical” solutions to the power oscillation caused by the GPU server clusters involve expensive storage techniques (e.g., batteries and/or capacitors) or wasted energy in “dummy loads” (e.g., resistive banks and/or heaters). Batteries and capacitors further occupy floorspace within a datacenter that could otherwise be occupied by additional GPUs or other equipment and add potential points of failure to the distributed computation system.

Some power delivery systems may incorporate flow batteries as part of the energy storage and delivery solution, particularly using piped electrolyte to distribute power directly to storage racks. Further, for longer duration fluctuations in power consumption (e.g., milliseconds or greater, referred to herein as “slow” fluctuations), flow batteries may store power during off-peak demand periods and release power during peak demand periods, thereby reducing the required peak power required of a power source. However, flow batteries typically do not react fast enough to compensate for rapid fluctuations in power consumption (e.g., fluctuations occurring within less than a millisecond, referred to herein as “fast” fluctuations), such as that experienced by GPU clusters performing distributed computational workloads. UPS systems are often used to compensate for rapid fluctuations in power consumption, but they suffer from the disadvantages described above.

The presently disclosed technology offers a pathway to improve the overall reliability and availability of a power delivery system that incorporates a flow battery system. The presently disclosed technology supplements or replaces some or all of fast acting capacitive UPS systems, increases a computing network’s resiliency against highly synchronous workloads, and improves the overall energy storage capacity of the power delivery system.

Specifically, the presently disclosed technology utilizes the pipework of electrolyte distribution systems in place for the flow battery as a distributed electrolytic capacitor. The existing piping infrastructure for the flow battery is aimed at delivering electrolyte from a main electrolyte tank directly to server racks, where it is converted to electricity. As a result, total length of electrolyte piping runs can be significant (e.g., hundreds of meters) and span the length of an entire datacenter multiple times to deliver the electrolyte to the numerous server racks therein.

The electrolyte pipework has vast amount of available surface area of solid-liquid interfaces between the pipe wall and the electrolyte. This interface, effectively available “for free”, can be inexpensively retrofit to form a distributed capacitor, capable of storing an electric charge. Since the energy-storage rating of electrolytic capacitors depends on the surface area of the dielectric interface, a significant amount of energy can be stored at the solid-liquid interfaces of these existing electrolyte pipework systems. This form of “fast” energy storage is ideally suited to complement “slow” chemical energy storage, capable of acting as a power-smoothing solution and a UPS supplement or replacement.

The disclosed distributed electrolytic capacitors are technically advantageous over purely electrical solutions, and other solutions for “fast” energy storage, by requiring few changes to the flow battery design already implemented for “slow” chemical energy storage within a power delivery system. As compared to traditional capacitors, the presently disclosed distributed electrolytic capacitor utilize the same electrolyte as the underlying flow battery. This electrolyte is closely monitored in terms of volume and temperature for proper functioning as a flow battery. Adopting a distributed electrolytic capacitor using the same electrolyte removes an otherwise present point of failure as traditional electrolytic capacitors utilize discrete fixed electrolyte reservoirs that may leak or evaporate the electrolyte away, leading to reduced functionality or failure of the capacitor. Further, it is difficult to detect such failures across of a body of discrete reservoirs, each assigned to a traditional electrolytic capacitor. Still further, electrolytic capacitors are sensitive to heat. As the electrolyte within the flow battery is already managed for temperature (e.g., using heat exchangers and/or a large reservoir of electrolyte as a thermal sink), the presently disclosed distributed electrolytic capacitor may take advantage of this thermal management of the electrolyte for the flow battery without additional risk or potential point of failure. In sum, the singular body of electrolyte that is already being monitored and managed as a part of the flow battery essentially eliminates these points of failure that would otherwise be additional to possible failure of the flow battery system.

Further, few if any infrastructure upgrades may be required to implement the presently disclosed distributed electrolytic capacitor power smoothing devices and methods. Further, power management software could be updated to utilize the disclosed technology without any hardware changes. In comparison, resistor banks and UPS-based solutions require power infrastructure upgrades and local battery-based solutions require changes to PSUs / server chassis. Further, the presently disclosed distributed electrolytic capacitor power smoothing devices and methods are very low wear as compared to chemical-based storage (e.g., batteries and UPS) as there are no additional moving parts or chemical reactions that are no preexisting within the underlying flow battery. Further still, the presently disclosed distributed electrolytic capacitor power smoothing devices and methods can achieve a net power savings while being as reliable as or more reliable than batteries and UPSs.

Compared to any existing UPS or backup power system, the presently disclosed technology offers the following potential technical benefits. The purely “electric” nature of capacitive energy storage eliminates additional conversion steps required for chemical energy extraction (e.g., internal combustion engines for diesel energy extraction, fuel cells for hydrogen energy extraction, etc.), thereby simplifying systems and making them more cost competitive and potentially reliable. For DC-powered solutions, no active switching of the load to the backup systems is required, as compared to diesel generators. Distributed capacitors can be connected in series with the load, naturally acting as a voltage source whenever power interruption occurs. Capacitors have a fast reaction time, particularly in comparison to chemical energy storage. Capacitors store energy in the form of electric field, which is readily available for use in the shortest timespans.

Compared to conventional power smoothing solutions, utilizing traditional capacitor banks, the presently disclosed technology offers the following potential technical benefits. Distributed capacitive energy storage for flow batteries utilizes existing “free” solid-liquid interfaces retrofittable to electrolytic capacitors, improving cost competitiveness. The distributed nature of capacitors improves resilience and reduces “blast radius” of failures compared to concentrated capacitor banks.

The presently disclosed technology offers the following further potential technical benefits. The buffer liquid electrolyte storage can be used as integrated UPS, but the presently disclosed technology improves the UPS capacity through distributed capacitance. The combination is more effective than either UPS capacity alone (e.g., by combining “fast” and “slow” power fluctuation response). Further, distributed capacitance complements chemical energy storage with a more responsive electric field storage (e.g., “fast” power fluctuation response, discussed above). Flow battery-based power distribution systems often already include lengthy electrolyte delivery pipework, which can be cheaply retrofit to a capacitive electric charge storage system. The result is energy storage with a faster reaction time that complements a flow battery’s conventional energy storage capacities.

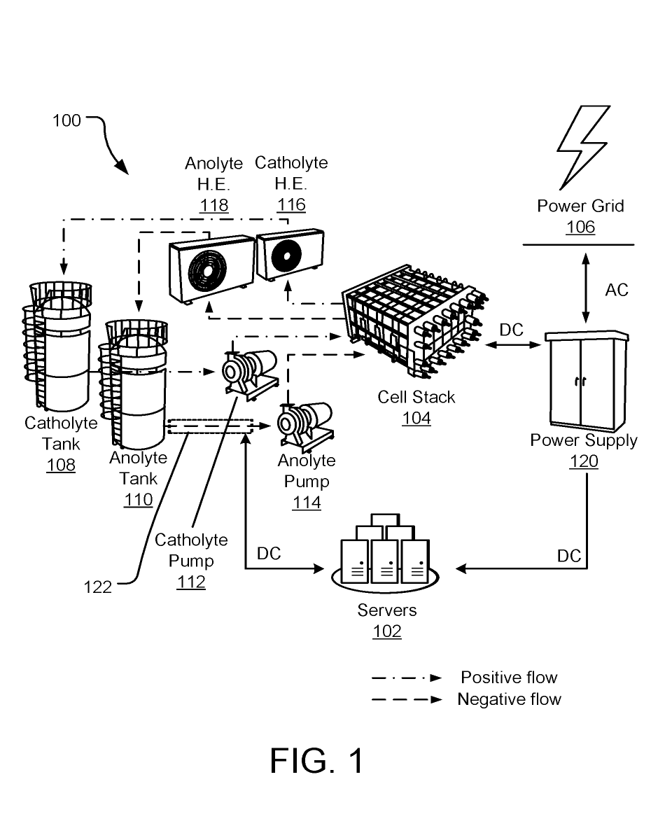

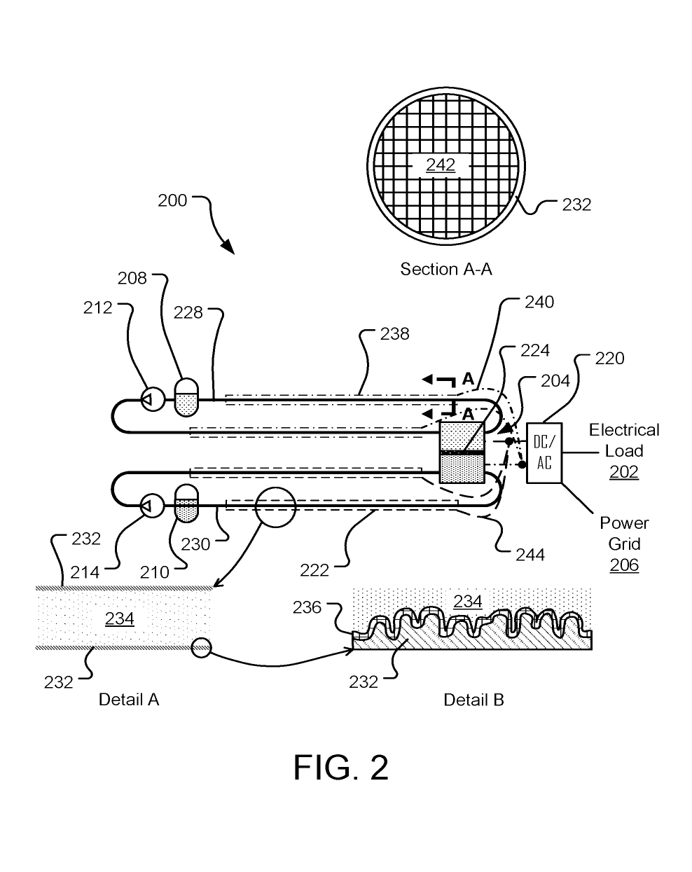

FIG. 1 illustrates a graphical configuration of a flow battery 100 with distributed capacitive energy storage powering an array of servers 102. The flow battery 100, (also referred to as a reduction–oxidation (redox) flow battery) utilizes electrochemical cells (cell stack 104) to bi-directionally convert between electrical energy and chemical energy. The chemical energy is provided by electroactive chemical components dissolved in a liquid (i.e., an anolyte and a catholyte, both referred to herein as electrolytes) that is pumped through the flow battery 100 on separate sides of membranes (not shown, see e.g., membrane 224 of FIG. 2) separating each of the electrochemical cells. Ions transfer inside the cell stack 104 and across the membranes while the electrolytes circulate in their respective flow paths to bi-directionally convert between electrical energy and chemical energy.

The flow battery 100 may be used like a rechargeable battery, where an electric power source, such as power grid 106, drives regeneration of the anolyte and the catholyte. However, a fundamental difference between a conventional battery and flow batteries, such as flow battery 100, is that energy is primarily stored in electrode material in conventional batteries, while in flow batteries the energy is primarily stored in the electrolytes. As such, flow batteries may have certain technical advantages over conventional rechargeable batteries with solid electroactive materials, such as independent scaling of power (as determined by the size of the cell stack 104) and of energy (as determined by the size of the electrolyte tanks 108, 110), long cycle and calendar life, and potentially lower total cost of ownership. A further advantage of flow batteries is the ability to adopt distributed capacitive energy storage using existing flow battery componentry per the presently disclosed technology, as detailed below.

Excess electrolyte is stored within the flow battery 100, with catholyte in a catholyte tank 108 and anolyte in an anolyte tank 110 and is pumped through the electrochemical cells of the cell stack 104 using catholyte pump 112 and anolyte pump 114, respectively. Further, the electrolyte functions most efficiently when kept within operating temperatures (e.g., -20 to 55 °C) as the electrolyte may include volatile and flammable organic solvents and thermally unstable salts. As a result, the flow battery 100 is equipped with heat exchangers (HEs) 116, 118, specifically, catholyte HE 116 and anolyte HE 118, which are particularly used to avoid heating the electrolyte above its operating temperatures.

The array of servers 102 may comprise one or more server racks, each of which having a set of processors, such as graphical processing units (GPUs). Each of the server racks may further include a rack controller and a power supply for example, and other and different quantities of components as server racks are often modular in nature. Further, the array of servers 102 is contemplated as one of many within a data center.

The array of servers 102 may include GPU processors that operate with a synchronous and fluctuating computational workload when used for ML and/or AI model training. This yields a synchronous and fluctuating net power consumption over time that fluctuates between a minimum power consumption with the GPU processors substantially idled when a collecting operation executed between computational workloads is running and a maximum power consumption with the GPU processors are fully loaded with computational workload before and after each collecting operation. This causes rapid fluctuations in power consumption (e.g., fluctuations occurring within less than a millisecond, referred to herein as “fast” fluctuations). While the array of servers 102 are explicitly disclosed herein as containing GPUs, other server and processor types that function with a periodically and repeatedly fluctuating workload and resulting power consumption may similarly adopt distributed capacitive energy storage operating as a power-smoothing solution and a UPS supplement or replacement.

Power supply 120 is used as primary power for the array of servers 102, though the server racks within the array of servers 102 may also include similar power supplies dedicated to specific server racks or individual servers. The power supply 120 is considered to encompass any one or more power supplies that condition power for an entire data center, the array of servers 102, server racks within the array of servers 102, and servers within the server racks. The power supply 120 is powered by the power grid 106, one or more batteries, or other external power sources. The power supply 120 may also include its own internal power sources, such as batteries or capacitors to store energy for momentary interruptions of power. The external power source may recharge the internal batteries or capacitors when power is available. As the power grid 106 generally supplies alternating current (AC) power, while the cell stack 104 and the array of servers 102 store and consume direct current (DC) power, the power supply 120 is capable for converting between AC and DC power and stepping voltage up or down as needed for the power grid 106, cell stack 104, and servers 102. While one power supply 120 is shown for converting between AC and DC power and conditioning voltage, other implementations may adopt two or more separate components for converting between AC and DC power and conditioning voltage. The power supply 120 is illustrative of any number of these components.

The cell stack 104 can bi-directionally convert between electrical energy and chemical energy, thereby storing excess electricity received from the power grid 106 within the electrolyte as chemical energy and releasing the stored chemical energy as electrical power for the servers 102 to bridge momentary interruptions of power. Still further, the cell stack 104 may be used to partially power the servers 102 even when there is no interruption of power. Use of the flow battery 100 is technically advantageous in that it provides an uninterruptible power supply (UPS), thermo-mechanical power smoothing, and/or electrical power efficiency benefits that would otherwise be unavailable to the servers 102.

However, the cell stack 104 is only effective for longer duration fluctuations in power consumption (e.g., milliseconds or greater, referred to herein as “slow” fluctuations), as the flow battery 100 may store power during off-peak demand periods and release power during peak demand periods, thereby reducing the required peak power required of a power source. However, the flow battery 100 may not react fast enough to compensate for fast fluctuations, such as that experienced by GPU clusters performing distributed computational workloads within the servers 102. UPS systems are often used to compensate for rapid fluctuations in power consumption, but they suffer from the disadvantages described above.

To supplement or replace a UPS system and compensate for fast fluctuations at the servers 102, the flow battery 100 is equipped with distributed capacitive energy storage. The distributed capacitive energy storage utilizes one or more sections (e.g., section 122) of the pipework connecting the components of the flow battery 100 that are already in place as a distributed electrolytic capacitor. The existing piping infrastructure for the flow battery 100 is aimed at delivering electrolyte from the electrolyte tanks 108, 110 to the cell stack 104, where chemical energy is converted to electricity or vice versa. Further, many implementations of the flow battery 100 will adopt multiples of the cell stack 104, each physically adjacent subsets of the servers 102 that are intended to be powered. As a result, total length of electrolyte piping runs can be significant (e.g., hundreds of meters) and span the length of an entire datacenter multiple times to deliver the electrolyte to the numerous server racks therein.

The resulting electrolyte pipework has vast amount of available surface area of solid-liquid interfaces between the pipe wall and the electrolyte. This interface, effectively available “for free”, can be inexpensively retrofit to form a distributed capacitor, capable of storing an electric charge. Since the energy-storage rating of electrolytic capacitors depends on the surface area of the dielectric interface, a significant amount of energy can be stored at the solid-liquid interfaces of these existing electrolyte pipework systems. The electrolytic capacitor is then electrically connected to the servers 102 in a bi-directional manner.

The electrolytic capacitor can store electric energy statically by charge separation in an electric field in a dielectric oxide layer between the pipe wall acting as a first electrode and the electrolyte acting as a second electrode. The electrolytic capacitor can release the electric energy as electrical power for the servers 102 to bridge momentary interruptions of power. This form of “fast” energy storage is well suited to complement the “slow” chemical energy storage of the flow battery 100 and is capable of acting as a power-smoothing solution and a UPS supplement or replacement.

FIG. 2 is a diagram of a flow battery 200 with distributed capacitive energy storage powering an electrical load 202. The flow battery 200 utilizes an electrochemical cell 204 to bi-directionally convert between electrical energy and chemical energy. The chemical energy is provided by electroactive chemical components dissolved in a liquid (i.e., an anolyte and a catholyte, both referred to herein as electrolytes) that is pumped through the flow battery 200 on separate sides of membrane 224 separating anode and cathode sides of the electrochemical cells 204. Ions transfer inside the cells 204 and across the membranes 224 while the electrolytes circulate in their respective flow paths to bi-directionally convert between electrical energy and chemical energy. While a singular cell 204 connected to power grid 206 and the electrical load 202 via power supply 220 is illustrated, additional cells may be connected within the flow battery 200 to power additional electrical loads, such as server loads, and/or connect to additional external power sources.

Excess electrolyte is stored within the flow battery 200, with catholyte in a catholyte tank 208 and anolyte in an anolyte tank 210 and is pumped through the electrochemical cell 204 using catholyte pump 212 and anolyte pump 214. The flow battery 200 may be used like a rechargeable battery, where an electric power source, such as power grid 206, drives regeneration of the anolyte and the catholyte. However, a fundamental difference between a conventional battery and flow batteries, such as flow battery 200, is that energy is primarily stored in electrode material in conventional batteries, while in flow batteries the energy is primarily stored in the electrolytes. An advantage of the flow battery 200 is its ability to adopt distributed capacitive energy storage using existing flow battery componentry per the presently disclosed technology, as detailed below.

The electrical load 202 may be characterized as a singular discrete server load. The server load may comprise one or more server racks, each of which having a set of processors, such as graphical processing units (GPUs). Each of the server racks may further include a rack controller and a power supply for example, and other and different quantities of components as server racks are often modular in nature. Further, the server load is contemplated as one of many within a data center and may include other loads not directly tied to operation of a server, including a singular discrete non-server load.

Power supply 220 is used as an AC / DC converter or voltage conditioner for the power grid 206 and the electrical load 202. By pairing power supplies with power sources or loads, electrolyte pipe networks 228, 230 function as pathways for transmitting power at low losses. While not shown, additional pairings of power supplies and loads may be included throughout the flow battery 200 and within the electrolyte pipe networks 228, 230. In other implementations, the electrical system powered by the flow battery 200 operates exclusively in AC or DC. In such implementations, the power supply 220 serves as a power distribution hub and optionally, a voltage conditioner, without AC / DC conversion.

The electrochemical cell 204, which may be one of an associated cell stack (see e.g., cell stack 104 of FIG. 1) can bi-directionally convert between electrical energy and chemical energy, thereby storing excess electricity received from the power grid 206 within the electrolyte as chemical energy and releasing the stored chemical energy as electrical power for the electrical load 202 to bridge momentary interruptions of power. Still further, the electrochemical cell 204 may be used to partially power the electrical load 202 even when there is no interruption of power. Use of the flow battery 200 is technically advantageous in that it provides an uninterruptible power supply (UPS), thermo-mechanical power smoothing, and/or electrical power efficiency benefits that would otherwise be unavailable to the electrical load 202.

However, the electrochemical cell 204 is only effective for longer duration fluctuations in power consumption (e.g., milliseconds or greater, referred to herein as “slow” fluctuations), as the flow battery 200 may store power during off-peak demand periods and release power during peak demand periods, thereby reducing the required peak power required of a power source. However, the flow battery 200 may not react fast enough to compensate for fast fluctuations, such as that experienced by GPU clusters performing distributed computational workloads within the electrical load 202. UPS systems are often used to compensate for rapid fluctuations in power consumption, but they suffer from the disadvantages described above.

To supplement or replace a UPS system and compensate for fast fluctuations at the electrical load 202, the flow battery 200 is equipped with distributed capacitive energy storage. The distributed capacitive energy storage utilizes one or more sections (e.g., section 222) of the electrolyte pipe networks 228, 230 connecting the components of the flow battery 200 that are already in place as a distributed electrolytic capacitor. The existing electrolyte pipe networks 228, 230 for the flow battery 200 are aimed at delivering electrolyte from the electrolyte tanks 208, 210 to the electrochemical cell 204, where chemical energy is converted to electricity or vice versa. In other implementations, the electrolyte tanks 208, 210 are omitted.

The electrolyte pipe networks 228, 230 have vast amount of available surface area of solid-liquid interfaces between the pipe wall and the electrolyte. This interface, effectively available “for free”, can be inexpensively retrofit to form a distributed capacitor, capable of storing an electric charge. Since the energy-storage rating of electrolytic capacitors depends on the surface area of the dielectric interface, a significant amount of energy can be stored at the solid-liquid interfaces of the electrolyte pipe networks 228, 230. The electrolytic capacitor is then electrically connected to the electrical load 202 in a bi-directional manner.

Detail A is a longitudinal section of the section 222 of the electrolyte pipe network 230 and shows the metal pipe wall 232 serving as an anode for the electrolytic capacitor and the electrolyte 234 flowing therethrough serving as a cathode for the electrolytic capacitor. Detail B shows a closer view of one side of the metal pipe wall 232, with a dielectric layer 236 deposited therebetween. The electrolytic capacitor can store electric energy statically by charge separation in an electric field in the dielectric layer 236 between the metal pipe wall 232 acting as a first electrode (e.g., an anode) and the electrolyte 234 acting as a second electrode (e.g., a cathode). For the opposite side of the flow battery 200 (e.g., electrolyte pipe network 228), the metal pipe wall acts as a cathode and the electrolyte acts as an anode. The electrolytic capacitor can release the electric energy as electrical power for the electrical load 202 to bridge momentary interruptions of power. This form of “fast” energy storage is well suited to complement the “slow” chemical energy storage of the flow battery 200 and is capable of acting as a power-smoothing solution and a UPS supplement or replacement.

The metal pipe wall 232 may be of any electrically conductive metal alloy, such as an aluminum, copper, steel, tantalum, or titanium alloy, provided as examples. The electrolyte 234 may be the anolyte or the catholyte for the flow battery 200. The dielectric layer 236 may be an oxide of the metal pipe wall 232 (e.g., aluminum oxide) or another insulating coating applied over the metal pipe wall 232 and keeping the metal pipe wall 232 electrically isolated from the electrolyte 234. The metal pipe wall 232 may further be etched or mechanically textured, as shown, to increase contact area with the electrolyte 234 (with the dielectric layer 236 therebetween). This increases the electrical storage capacity of the solid-liquid interfaces of the electrolyte pipe networks 228, 230, as this is a function of surface area of the dielectric interface. While Details A and B are specific to electrolytic capacitor section 222 of the electrolyte pipe network 230, other electrolytic capacitor sections within one or both of the electrolyte pipe networks 228, 230 may be structurally and functionally similar.

Section A-A is a cross section of the electrolyte pipe network 228 at an end of section 238 functioning as an electrolytic capacitor, where a lead 240 connects the section 238 to the power supply 220. As charging and discharging the section 238 to function as an electrolytic capacitor works most efficiently with a greater surface area of contact with the electrolyte 234, a conductive mesh 242 or other mechanical structure (e.g., another concentric pipe, a spiral structure, a single rod, or an isolated portion of the metal pipe wall 232) may be placed within the metal pipe wall 232, and potentially span its cross section, to increase this contact surface area and better extract electrons from the electrolyte 234. The size, shape, and configuration of the conductive mesh 242, and its resulting effect on electrolytic capacitor charge / discharge rate is balanced against the resulting flow restriction caused by the mesh 242.

Additional leads may connect additional sections of the electrolyte pipe network 228 to the power supply 220 using conductive meshes. Similarly, additional leads (e.g., additional lead 244) connect sections of the electrolyte pipe network 230 (e.g., section 222) to the power supply 220 using conductive meshes. These connections of the leads (serving as cathode or anode leads) electrically connect the electrolytic capacitance of the electrolyte pipe networks 228, 230 to the power supply 220, and in turn the electrical load 202. In some implementations, the conductive mesh 242 and associated lead may be implemented periodically within a pipe section, particularly where the pipe section is lengthy and there are significant losses incurred by only adopting one conductive mesh 242. While Section A-A is specific to electrolytic capacitor section 238 of the electrolyte pipe network 228, other electrolytic capacitor sections within one or both of the electrolyte pipe networks 228, 230 may be structurally and functionally similar.

In other implementations, the presently disclosed technology may be implemented without the electrolyte pipe networks 228, 230 and instead using the walls of the electrolyte tanks 208, 210 as capacitive energy storage. In such implementations, Details A and B and Section A-A would apply equally to the walls of the electrolyte tanks 208, 210 as described above with regard to the electrolyte pipe networks 228, 230. Further, while the presently disclosed technology is discussed in detail in the context of adoption into a flow battery, any suitable network of pipes that flow a conductive fluid could similarly adopt distributed capacitance (e.g., a liquid coolant system that flow a conductive coolant, such as one that include entrained corrosion inhibitors). In such implementations, the electrochemical cell 204 would be omitted, but other features and components of the flow battery 200 would remain present, particularly the pipe networks 228, 230, that may not flow an electrolyte.

Such implementations may be described as a fluid system with capacitive energy storage. The fluid system may include power supply 220 and fluid reservoirs (e.g., the tanks 208, 210 and/or the electrolyte pipe networks 228, 230) functioning as reservoirs for any conductive fluid (e.g., electrolyte 234) serving as a cathode for the capacitive energy storage. One or more sections of the fluid reservoirs includes a metal contact (e.g., the metal pipe wall 232) running about an interior of the fluid reservoir and serves as an anode for the capacitive energy storage. An insulating coating (e.g., the dielectric layer 236) is applied over the metal contact and separates the metal contact from the conductive fluid. The insulating coating serves as a dielectric for the capacitive energy storage. The lead 240 runs from the metal contact to the power supply 220 and connects the capacitive energy storage of the fluid reservoir to the power supply 220. In some implementations, a second lead that pairs with lead 240 and connects the electrolyte 234 to the power supply 220.

Where the fluid system is a flow battery, such as flow battery 200, the system further comprises the electrochemical cell 204 to reversibly convert between chemical energy stored in the electrolyte 234 and electrical energy. The power supply 220 is connected to the electrochemical cell 204 and the conductive fluid is the electrolyte 234. Where the fluid reservoir includes the pipe networks 228, 230 to circulate the conductive fluid within the fluid system, the metal contact runs an interior length of one or both of the pipe networks 228, 230. In some implementations, the metal contact may be discontinuous (e.g., a set of radial rings arranged in a row along the interior length) and individually none extend along much of the interior length, but the discontinuous metal contacts in sum do run an interior length of one or both of the pipe networks 228, 230.

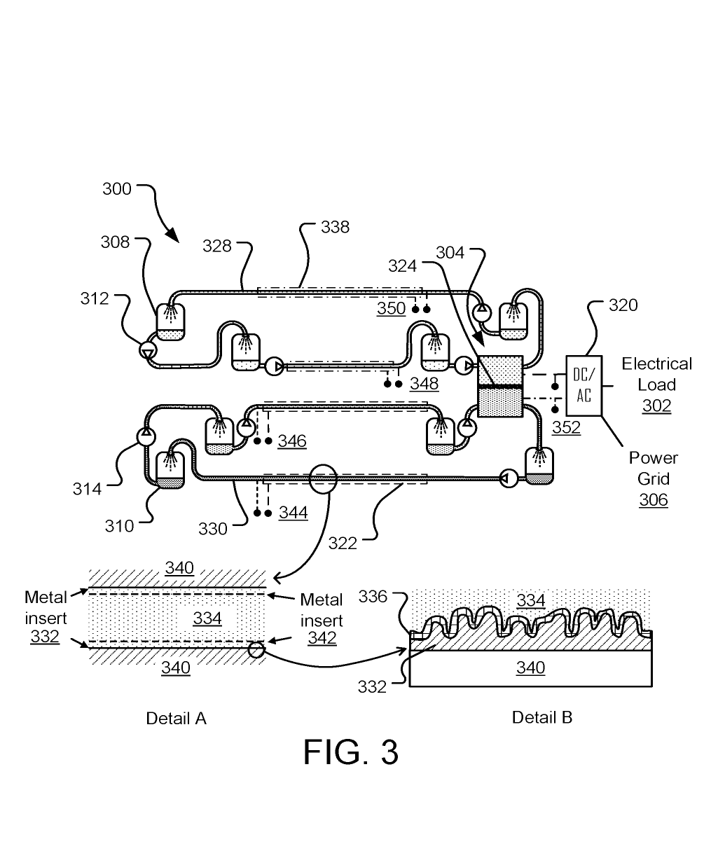

FIG. 3 is a diagram of a flow battery 300 with independent distributed capacitive energy storage powering an electrical load 302. The flow battery 300 utilizes electrochemical cell 304 to bi-directionally convert between electrical energy and chemical energy. The chemical energy is provided by electroactive chemical components dissolved in a liquid (i.e., an anolyte and a catholyte, both referred to herein as electrolytes) that is pumped through the flow battery 300 on separate sides of membrane 324 separating anode and cathode sides of each of the electrochemical cell 304. Ions transfer inside the cell 304 and across the membrane 324 while the electrolytes circulate in their respective flow paths to bi-directionally convert between electrical energy and chemical energy. While a singular cell 304 for power grid 306 and the electrical load 302 is illustrated, additional cells may be connected within the flow battery 300 to power additional electrical loads, such as server loads, and/or connect to additional external power sources.

Excess electrolyte is stored within the flow battery 300, with catholyte in catholyte tanks (e.g., catholyte sprayer tank 308) and anolyte in anolyte tanks (e.g., anolyte sprayer tank 310). The electrolyte is pumped through the electrochemical cell 304 using pumps (e.g., catholyte pump 312 and anolyte pump 314). The anolyte and catholyte tanks of FIG. 3 additionally serve as non-conductive separators that electrically separate sections (e.g., sections 322, 338) of electrolyte pipe networks 328, 330 to define independent distributed capacitive energy storage for each of the electrically distinct sections. In other implementations, the anolyte and catholyte tanks do not serve as non-conductive separators and are electrically continuous, such as electrolyte tanks 208, 210 of FIG. 2. The non-conductive separators are separate structures included within the flow battery 300 to define the electrically distinct sections. In some implementations, the pumps (e.g., catholyte pump 312 and anolyte pump 314) are used as non-conductive separators. Additional pumps may be included within the flow battery 300, as depicted, due to a non-continuous electrolyte flow through the electrolyte pipe networks 328, 330 introduced by the non-conductive separators. In other implementations, the anolyte and catholyte tanks are omitted.

The non-conductive separators may take a variety of forms but may be characterized as either flow re-direction separators or mechanical separators. Flow re-direction separators, such as that depicted by tanks 308, 310 of FIG. 3 introduce breaks in the fluid flow by redirecting the fluid flow. The redirection may be achieved by spraying an inlet flow into a body of fluid connected to an outlet or dripping the inlet flow into the body of fluid connected to the outlet. The flow re-direction separators may further include mechanical devices to introduce or supplement flow re-direction, such as passing the flow through a mesh or a series of baffles.

Mechanical separators, such as particular types of pumps (e.g., catholyte pump 312 and anolyte pump 314), introduce electric breaks in the fluid flow by mechanically separating the fluid flow as it passes through the pump. Most volumetric pumps, if they adopt non-conductive internal components, can achieve these electric breaks (e.g., gear, lobe, van, screw, scroll, and peristaltic pumps). While these pumps may have some continuity through these seals, a dramatic increase in resistance may be enough for the purposes of the presently disclosed technology, even if not a complete break in continuity.

The flow battery 300 may be used like a rechargeable battery, where an electric power source, such as the power grid 306, drives regeneration of the anolyte and the catholyte. However, a fundamental difference between a conventional battery and flow batteries, such as flow battery 300, is that energy is primarily stored in electrode material in conventional batteries, while in flow batteries the energy is primarily stored in the electrolytes. An advantage of the flow battery 300 is its ability to adopt independent distributed capacitive energy storage using existing flow battery componentry per the presently disclosed technology, as detailed below. A further advantage of the flow battery 300 as compared to the flow battery 200 of FIG. 1 is that the distributed capacitive energy storage defined by sections of the electrolyte pipe networks 328, 330 are electrically independent. This allows the capacitive sections of the electrolyte pipe networks 328, 330 to be connected in series and/or in parallel to achieve a voltage closest to that consumed by the electrical load 302. This also allows subsets of capacitive sections of the electrolyte pipe networks 328, 330 to be connected to different electrical loads, including but not limited to the electrical load 302.

The electrical load 302 may be characterized as a server load. The server load may comprise one or more server racks, each of which having a set of processors, such as graphical processing units (GPUs). Each of the server racks may further include a rack controller and a power supply for example, and other and different quantities of components as server racks are often modular in nature. Further, the server load is contemplated as one of many within a data center.

Power supply 320 is used as an AC / DC converter and voltage conditioner for the power grid 306 and the electrical load 302. By pairing power supplies with power sources or loads, the electrolyte pipe networks 328, 330 function as pathways for transmitting power at low losses. While not shown, additional pairings of power supplies and loads may be included throughout the flow battery 300 and within the electrolyte pipe networks 328, 330. In other implementations, the electrical system powered by the flow battery 300 operates exclusively in AC or DC. In such implementations, the power supply 320 serves as a power distribution hub and optionally, a voltage conditioner, without AC / DC conversion.

The electrochemical cell 304, which may be one of an associated cell stack (see e.g., cell stack 104 of FIG. 1) can bi-directionally convert between electrical energy and chemical energy, thereby storing excess electricity received from the power grid 306 within the electrolyte as chemical energy and releasing the stored chemical energy as electrical power for the electrical load 302 to bridge momentary interruptions of power. Still further, the electrochemical cell 304 may be used to partially power the electrical load 302 even when there is no interruption of power. Use of the flow battery 300 is technically advantageous in that it provides an uninterruptible power supply (UPS), thermo-mechanical power smoothing, and/or electrical power efficiency benefits that would otherwise be unavailable to the electrical load 302.

However, the electrochemical cell 304 is only effective for longer duration fluctuations in power consumption (e.g., milliseconds or greater, referred to herein as “slow” fluctuations), as the flow battery 300 may store power during off-peak demand periods and release power during peak demand periods, thereby reducing the required peak power required of a power source. However, the flow battery 300 may not react fast enough to compensate for fast fluctuations, such as that experienced by GPU clusters performing distributed computational workloads within the electrical load 302. UPS systems are often used to compensate for rapid fluctuations in power consumption, but they suffer from the disadvantages described above.

To supplement or replace a UPS system and compensate for fast fluctuations at the electrical load 302, the flow battery 300 is equipped with independent distributed capacitive energy storage. The independent distributed capacitive energy storage utilizes one or more electrically independent sections (e.g., section 322) of the electrolyte pipe networks 328, 330 connecting the components of the flow battery 300 that are already in place as independent distributed electrolytic capacitors. The existing electrolyte pipe networks 328, 330 for the flow battery 300 are aimed at delivering electrolyte from the electrolyte tanks to the electrochemical cell 304, where chemical energy is converted to electricity or vice versa.

The electrolyte pipe networks 328, 330 have vast amount of available surface area of solid-liquid interfaces between the pipe wall and the electrolyte. This interface, effectively available “for free”, can be inexpensively retrofit to form a distributed capacitor, capable of storing an electric charge. Since the energy-storage rating of electrolytic capacitors depends on the surface area of the dielectric interface, a significant amount of energy can be stored at the solid-liquid interfaces of the electrolyte pipe networks 328, 330. The independent electrolytic capacitors are then electrically connected to the electrical load 302, or other loads, in a bi-directional manner.

Detail A is a longitudinal section of the section 322 of the electrolyte pipe network 330 and shows a plastic pipe wall 340 with a concentric metal pipe liner 332 serving as an anode for the electrolytic capacitor and the electrolyte 334 flowing therethrough serving as a cathode for the electrolytic capacitor. In some implementations, an additional conductive mesh insert 342 is placed concentrically inside of the concentric metal pipe liner 332. As charging and discharging the section 322 to function as an independent electrolytic capacitor works most efficiently with a greater surface area of contact with the electrolyte 334, the conductive mesh insert 342 or other mechanical structure (e.g., another concentric pipe, a spiral structure, a single rod, or an isolated portion of the concentric metal pipe liner 332) may be placed within the metal pipe liner 332 to increase this contact surface area and better extract electrons from the electrolyte 334. The size, shape, and configuration of the conductive mesh insert 342, and its resulting effect on electrolytic capacitor charge / discharge rate is balanced against the resulting flow restriction caused by the conductive mesh insert 342.

Detail B shows a closer view of one side of the section 322 of the electrolyte pipe network 330. The plastic pipe wall 340 is shown on the outside with the concentric metal pipe liner 332 concentrically inside of the plastic pipe wall 340. In various implementations, the metal pipe liner 332 may be molded or deposited within the plastic pipe wall 340, or vice versa, during construction of the electrolyte pipe network 330. A dielectric layer 236 is deposited or otherwise placed or developed on the metal pipe liner 332 thereby electrically separating the metal pipe liner 332 from the electrolyte 334.

The independent electrolytic capacitors can store electric energy statically by charge separation in an electric field in the dielectric layer 236 between the metal pipe liner 332 acting as a first electrode (e.g., an anode) and the electrolyte 334 acting as a second electrode (e.g., a cathode). If present, the conductive mesh insert 342 also acts as the second electrode (e.g., the cathode) in conjunction with the electrolyte 334. For the opposite side of the flow battery 300 (e.g., electrolyte pipe network 328), the metal pipe liner acts as a cathode and the electrolyte and/or conductive mesh insert acts as an anode. The independent electrolytic capacitors can release the electric energy as electrical power for the electrical load 302, or other loads, to bridge momentary interruptions of power. This form of “fast” energy storage is well suited to complement the “slow” chemical energy storage of the flow battery 300 and is capable of acting as a power-smoothing solution and a UPS supplement or replacement.

The metal pipe liner 332 may be of any electrically conductive metal alloy, such as an aluminum, copper, or steel alloy. While depicted inside of the plastic pipe wall 340, in other implementations, the metal pipe liner 332 may be placed outside of the plastic pipe wall 340 and the plastic pipe wall 340 serves as the dielectric layer 336. Further, while the metal pipe liner 332 is depicted and described as a concentric liner for the plastic pipe wall 340, in other implementations the metal pipe liner 332 is merely a metal insert running lengthwise down an inside of the plastic pipe wall 340. The dielectric layer 336 still covers the metal insert but may similarly not extend concentrically within the plastic pipe wall 340. The plastic pipe wall 340 and internal metal pipe liner 332 may be technically advantageous over a metal pipe, such as metal pipe wall 232 of FIG. 2, as the plastic pipe wall 340 reduces the opportunity for an inadvertent ground or short with a relatively long conductive exterior of the electrolyte pipe networks 328, 330. Plastic is also more modular in that a transition to plastic pipe only (omitting the metal pipe liner 332) may be a simple mechanism to introduce electrical breaks between capacitive sections of the electrolyte pipe networks 328, 330. This yields a continuous plastic pipe wall 340, but a non-continuous metal pipe liner 332 within the electrolyte pipe networks 328, 330.

The electrolyte 334 may be the anolyte or the catholyte for the flow battery 300. The dielectric layer 336 may be an oxide of the metal pipe liner 332 (e.g., aluminum oxide) or another insulating coating applied over the metal pipe liner 332 and keeping the metal pipe liner 332 electrically isolated from the electrolyte 334. The metal pipe liner 332 may further be etched or mechanically textured, as shown, to increase contact area with the electrolyte 334 (with the dielectric layer 336 therebetween). This increases the electrical storage capacity of the solid-liquid interfaces of the electrolyte pipe networks 328, 330, as this is a function of surface area of the dielectric interface. While Details A and B are specific to independent electrolytic capacitor section 322 of the electrolyte pipe network 330, other independent electrolytic capacitor sections within one or both of the electrolyte pipe networks 328, 330 may be structurally and functionally similar.

As the independent electrolytic capacitor sections of FIG. 3 are treated as electrically independent of the electrochemical cell 304, each of the independent electrolytic capacitor sections includes a set of leads (see e.g., leads 344, 346, 348, 350) that may be connected together in series and/or parallel to achieve a desired voltage (e.g., connected in series to step-up voltage for a desired load) overall and operate as a charge pump. The leads may also be connected to discrete loads, including but not limited to the electrical load 302 at power supply 320 leads 352. For example, the leads may be directly connected server racks or individual servers therein through their individual power supplies, thereby bypassing the larger power supply 320. This may be technically advantageous in that by connecting the independent electrolytic capacitor sections closer to the fluctuating power loads of GPU servers, the independent electrolytic capacitor sections can operate more efficiently and react faster in suppressing fluctuating power loads.

For each of the sets of leads 344, 346, 348, 350, a first lead connects to the metal pipe liner 332, while a second lead connects to the electrolyte 334 (and optionally the conductive mesh insert 342). The dielectric layer 336 electrically separates the first lead from the second lead. These parings of the first and second leads (serving as cathode and anode leads) may be used to electrically connect the electrolytic capacitance of the electrolyte pipe networks 328, 330 to the power supply 320, and in turn the electrical load 302. If the parings of the leads are not electrically connected to the power supply 320, the power supply 320 may be electrically isolated from the electrolyte 334.

There are several potential technical advantages of multiple independent distributed capacitive energy storage, such as that of the flow battery 300, as compared to the distributed capacitive energy storage of flow battery 200 of FIG. 2. The flow battery 300 may be more resilient than flow battery 200 and continue to offer distributed capacitive energy storage, albeit at a reduced rate, even with a failure of one of the sections providing distributed capacitive energy storage. The flow battery 300 allows for increases the voltage through series connection(s) of capacitive energy storage (akin to a “charge pump”). The flow battery 300 may charge to and discharge from electrical systems separate from the flow battery 300 (e.g., supply lower voltage V_{dd} for CMOS chips in servers).

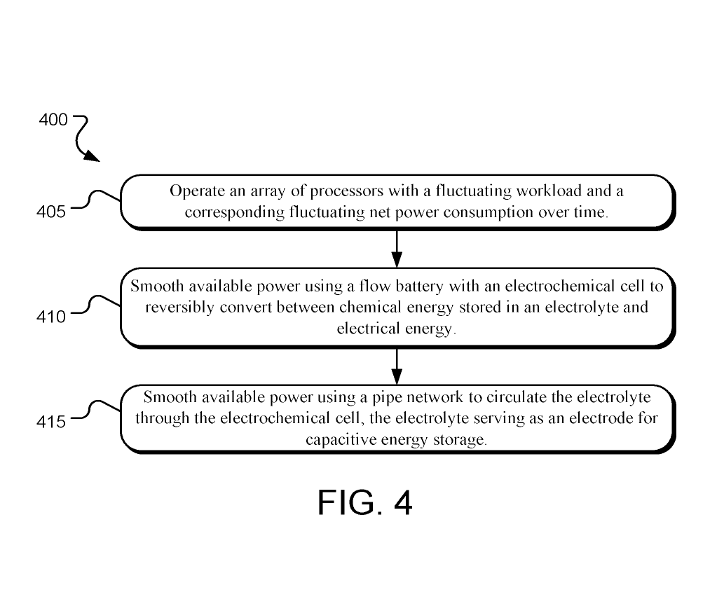

FIG. 4 illustrates example operations 400 for using a flow battery to smooth both “slow” and “fast” fluctuations in power consumption by a fluctuating power load. The flow battery functions as part of the energy storage and delivery solution using piped electrolyte to distribute power directly to storage racks. For longer duration fluctuations in power consumption (e.g., milliseconds or greater, referred to herein as “slow” fluctuations), the flow battery stores power during off-peak demand periods and releases power during peak demand periods, thereby reducing the required peak power required of a power source. However, flow batteries typically do not react fast enough to compensate for rapid fluctuations in power consumption (e.g., fluctuations occurring within less than a millisecond, referred to herein as “fast” fluctuations), such as that experienced by GPU clusters performing distributed computational workloads.

The presently disclosed technology utilizes the pipework of electrolyte distribution systems in place for the flow battery as a distributed electrolytic capacitor. The electrolyte pipework has vast amount of available surface area of solid-liquid interfaces between the pipe wall and the electrolyte. This interface, effectively available “for free”, forms a distributed capacitor, capable of storing an electric charge. This form of “fast” energy storage complements “slow” chemical energy storage and is capable of acting as a power-smoothing solution and a UPS supplement or replacement. While the operations 400 are specifically intended to achieve power smoothing for one or more servers, potentially within a server rack or even across a data center, other power loads are contemplated herein.

An operating operation 405 operates an array of processors with a fluctuating workload and a corresponding fluctuating net power consumption over time. The flow battery, primarily operating as conventionally designed and supplementary operating as a distributed electrolytic capacitor, in sum, operates as power smoothing device for the server(s) for both “slow” and “fast” fluctuations in power consumption by a fluctuating power load.

A first smoothing operation 410 smooths available power using a flow battery with an electrochemical cell to reversibly convert between chemical energy stored in an electrolyte and electrical energy. The first smoothing operation 410 is primarily to compensate for slow fluctuations in power consumption by the power load.

A second smoothing operation 415 smooths smoothing available power using a pipe network to circulate the electrolyte through the electrochemical cell, the electrolyte serving as a first electrode (cathode or anode) for the capacitive energy storage. The pipe network includes a metal contact running an interior length of the pipe network serving as a second electrode (cathode or anode) for the capacitive energy storage and an insulating coating applied over the metal contact and separating the metal contact from the electrolyte, the insulating coating serving as a dielectric for the capacitive energy storage. One or more leads connect the capacitive energy storage of the pipe network to the power load. The second smoothing operation 415 is primarily to compensate for fast fluctuations in power consumption by the array of processors.

The operations making up the embodiments of the presently disclosed technology are referred to variously as operations, steps, objects, or modules. The operations may be performed in any order, adding or omitting operations as desired, unless explicitly claimed otherwise or a specific order is inherently necessitated by the claim language.

Implementations described and claimed herein include a flow battery with capacitive energy storage. The flow battery comprises an electrochemical cell to reversibly convert between chemical energy stored in an electrolyte and electrical energy, a power supply connected to the electrochemical cell, and a pipe network to circulate the electrolyte through the electrochemical cell. The electrolyte serves as a first electrode for the capacitive energy storage. One or more sections of the pipe network includes a metal contact running an interior length of the pipe network serving as a second electrode for the capacitive energy storage, and an insulating coating applied over the metal contact and separating the metal contact from the electrolyte. The insulating coating serves as a dielectric for the capacitive energy storage. The flow battery further comprises a first lead running from the metal contact to the power supply. The lead connects the capacitive energy storage of the pipe network to the power supply.

The metal contact may be a metal pipe or a metal pipe liner.

The metal contact may be etched where the insulating coating is applied over the metal contact.

The insulating coating may be an oxide of the metal contact.

The metal contact may be an aluminum alloy. The insulating coating may be an aluminum oxide.

The pipe network may further include a conductive mesh spanning an interior cross section of the pipe network, wherein a second lead runs from the conductive mesh to the power supply.

The pipe network may further include a conductive mesh insert placed concentrically inside of the insulating coating within the pipe network, wherein the first lead runs from the conductive mesh insert to the power supply.

The pipe network may include one or more non-conductive separators that electrically separate two or more of the sections of the pipe network.

The non-conductive separators may include flow re-direction or mechanical separators.

The electrically separated sections of the pipe network may function as independent capacitive energy storage.

The electrically separated sections of the pipe network may be connected in series to step-up voltage for a combined capacitive energy storage.

The electrically separated sections of the pipe network may be continuous plastic pipes with non-continuous metal pipe liners.

The electrolyte may serve as a second lead to the power supply, the first and second leads to connect the capacitive energy storage of the pipe network to the power supply.

The power supply may be electrically isolated from the electrolyte, the flow battery may further comprise a second lead running from the electrolyte to the power supply, the first and second leads to connect the capacitive energy storage of the pipe network to the power supply.

The flow battery may further comprise a power source connected to the power supply, and an electrical load connected to the power supply.

The electrical load may be a singular discrete electrical load or a collection of separate electrical loads.

Implementations described and claimed herein also include a method of performing capacitive power smoothing for a server load. The method may comprise operating an array of processors with a fluctuating workload and a corresponding fluctuating net power consumption over time. For slow fluctuations in power consumption by the array of processors, the method may smooth available power using a flow battery with an electrochemical cell to reversibly convert between chemical energy stored in an electrolyte and electrical energy. For fast fluctuations in power consumption by the array of processors, method may smooth available power using a pipe network to circulate the electrolyte through the electrochemical cell, the electrolyte serving as a first electrode for the capacitive power smoothing. One or more sections of the pipe network may include a metal contact running an interior length of the pipe network serving as a second electrode for the capacitive power smoothing, and an insulating coating applied over the metal contact and separating the metal contact from the electrolyte. The insulating coating may serve as a dielectric for the capacitive power smoothing.

Implementations described and claimed herein also include a fluid system with capacitive energy storage comprising a power supply and a fluid reservoir to contain conductive fluid. The conductive fluid serves as a first electrode for the capacitive energy storage. One or more sections of the fluid reservoir includes a metal contact running about an interior of the fluid reservoir and serving as a second electrode for the capacitive energy storage, an insulating coating applied over the metal contact and separating the metal contact from the conductive fluid, the insulating coating serving as a dielectric for the capacitive energy storage. The fluid system further comprises a first lead running from the metal contact to the power supply. The first lead connects the capacitive energy storage of the fluid reservoir to the power supply.

The fluid system may be a flow battery. The flow battery further comprising an electrochemical cell to reversibly convert between chemical energy stored in an electrolyte and electrical energy. The power supply is connected to the electrochemical cell and the conductive fluid is an electrolyte.

The fluid reservoir may include a pipe network to circulate the conductive fluid within the fluid system, and the metal contact may run an interior length of the pipe network.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A flow battery with capacitive energy storage comprising:
an electrochemical cell to reversibly convert between chemical energy stored in an electrolyte and electrical energy;
a power supply connected to the electrochemical cell;
a pipe network to circulate the electrolyte through the electrochemical cell, the electrolyte serving as a first electrode for the capacitive energy storage, wherein one or more sections of the pipe network includes:
a metal contact running an interior length of the pipe network serving as a second electrode for the capacitive energy storage; and
an insulating coating applied over the metal contact and separating the metal contact from the electrolyte, the insulating coating serving as a dielectric for the capacitive energy storage; and
a first lead running from the metal contact to the power supply, the lead to connect the capacitive energy storage of the pipe network to the power supply.

2. The flow battery of claim 1, wherein the metal contact is a metal pipe or a metal pipe liner.

3. The flow battery of claim 1, wherein the metal contact is etched where the insulating coating is applied over the metal contact.

4. The flow battery of claim 1, wherein the insulating coating is an oxide of the metal contact.

5. The flow battery of claim 1, wherein the metal contact is an aluminum alloy, and the insulating coating is an aluminum oxide.

6. The flow battery of claim 1, wherein the pipe network further includes a conductive mesh spanning an interior cross section of the pipe network, wherein a second lead runs from the conductive mesh to the power supply.

7. The flow battery of claim 1, wherein the pipe network further includes a conductive mesh insert placed concentrically inside of the insulating coating within the pipe network, wherein the first lead runs from the conductive mesh insert to the power supply.

8. The flow battery of claim 1, wherein the pipe network includes one or more non-conductive separators that electrically separate two or more of the sections of the pipe network.

9. The flow battery of claim 8, wherein the non-conductive separators include flow re-direction or mechanical separators.

10. The flow battery of claim 8, wherein the electrically separated sections of the pipe network function as independent capacitive energy storage.

11. The flow battery of claim 10, wherein the electrically separated sections of the pipe network are connected in series to step-up voltage for a combined capacitive energy storage.

12. The flow battery of claim 11, wherein the electrically separated sections of the pipe network are continuous plastic pipes with non-continuous metal pipe liners.

13. The flow battery of claim 1, wherein the electrolyte serves as a second lead to the power supply, the first and second leads to connect the capacitive energy storage of the pipe network to the power supply.

14. The flow battery of claim 1, wherein the power supply is electrically isolated from the electrolyte, the flow battery further comprising:
a second lead running from the electrolyte to the power supply, the first and second leads to connect the capacitive energy storage of the pipe network to the power supply.

15. The flow battery of claim 1, further comprising:
a power source connected to the power supply; and
an electrical load connected to the power supply.

16. The flow battery of claim 15, wherein the electrical load is a singular discrete electrical load or a collection of separate electrical loads.

17. A method of performing capacitive power smoothing for a server load comprising:
operating an array of processors with a fluctuating workload and a corresponding fluctuating net power consumption over time;
for slow fluctuations in power consumption by the array of processors, smoothing available power using a flow battery with an electrochemical cell to reversibly convert between chemical energy stored in an electrolyte and electrical energy;
for fast fluctuations in power consumption by the array of processors, smoothing available power using a pipe network to circulate the electrolyte through the electrochemical cell, the electrolyte serving as a first electrode for the capacitive power smoothing, wherein one or more sections of the pipe network includes:
a metal contact running an interior length of the pipe network serving as a second electrode for the capacitive power smoothing; and
an insulating coating applied over the metal contact and separating the metal contact from the electrolyte, the insulating coating serving as a dielectric for the capacitive power smoothing.

18. A fluid system with capacitive energy storage comprising:
a power supply;
a fluid reservoir to contain conductive fluid, the conductive fluid serving as a first electrode for the capacitive energy storage, wherein one or more sections of the fluid reservoir includes:
a metal contact running about an interior of the fluid reservoir and serving as a second electrode for the capacitive energy storage; and
an insulating coating applied over the metal contact and separating the metal contact from the conductive fluid, the insulating coating serving as a dielectric for the capacitive energy storage; and
a lead running from the metal contact to the power supply, the lead to connect the capacitive energy storage of the fluid reservoir to the power supply.

19. The fluid system of claim 18, wherein the fluid system is a flow battery, further comprising:
an electrochemical cell to reversibly convert between chemical energy stored in an electrolyte and electrical energy, wherein the power supply is connected to the electrochemical cell, and wherein the conductive fluid is an electrolyte.

20. The fluid system of claim 18, wherein the fluid reservoir includes a pipe network to circulate the conductive fluid within the fluid system, and wherein the metal contact runs an interior length of the pipe network.
